(19) United States
(12) Patent Application Publication
(10) Pub. No.: US 2013/0268317 A1
(43) Pub. Date: Oct. 10, 2013

(54) ARRANGEMENT FOR FACILITATING SHOPPING AND RELATED METHOD

(71) Applicant: Samuli Mattila, Riihimaki (FI)

(72) Inventor: Samuli Mattila, Riihimaki (FI)

(73) Assignee: DIGITAL FOODIE OY, Helsinki (FI)

(21) Appl. No.: 13/990,223

(22) PCT Filed: Dec. 7, 2011
(86) PCT No.: PCT/FI2011/051079

§ 371 Date: May 29, 2013

(30) Foreign Application Priority Data
Dec. 7, 2010 (EP) 10193958.5

(51) Int. Cl. G06Q 30/06

(52) U.S. Cl. CPC G06Q 30/0631
USPC 705/7.29; 705/26.7

(57) ABSTRACT

An executing electronic arrangement for producing foodstuff recommendations and facilitating shopping in grocery stores, includes semantic context management entity configured to maintain semantic context-defining user information relative to a plurality of users, which indicates user preferences relative to groceries based on obtained explicit or implicit preference information, a base item recommendation entity configured to determine, for a first user, a plurality of more generic grocery recommendations based on the semantic context of the first user and the semantic contexts of a number of other users considered as neighbors to the first user according to predetermined similarity criteria, and a product recommendation entity configured to derive, for the first user, a shopping list incorporating a plurality of recommended products relative to a predetermined store offering such products, representing more specific instances of the determined more generic grocery recommendations and being derived utilizing knowledge of the store's product range or current stock.

### FIELD OF THE INVENTION

Generally the present invention relates to assisted shopping. In particular, however not exclusively, the present invention concerns at least partially automated shopping list generation based on methodology incorporating e.g. data mining and collaborative filtering.

### BACKGROUND

A plurality of electronic shopping list applications exists for various devices to help us with our daily grocery shopping as an electronic replacement to the traditional pen and paper lists. The user of such an application basically inputs personal reminders to purchase desired items from a local store. The shopping list can then be sent to the person doing the physical shopping or shared with other family members, for instance. Nowadays, the granularity of item details varies between the available solutions, generally corresponding to the level of crude base ingredients, but as the related technology progresses, more detailed information, such as product additives or real-time pricing, will become available. Since people both tend and like to do things with minimum effort, and the computers are expected to take care of many today's manual tasks, some kind of ultimate goal could imply automatic generation of a shopping list followed by automatic delivery of the groceries included therein from a suitable store to one's refrigerator.

Different implementations and concepts of intelligent shopping lists are known to exist varying from cloud platforms to mobile devices, intelligent refrigerators and computer enhanced shopping carts. Thus, the uses of such shopping lists are many, typically the purpose being to make our daily grocery shopping a bit easier and save us both time and money.

Historically, there have been some attempts to establish computer generated meal plans or shopping lists that have failed to achieve popularity. Such systems can be found for example in U.S. Pat. No. 7,249,708 that, such as many similar patents, presumes the existence of traceable purchase history through customer loyalty program bonus card; alas a rather trivial method tied to a specific customer loyalty system.

However, the found purchase history-derived methods have severe technical drawbacks. Most methods fail to take into account that there is, in general, too little source information to make meaningful recommendations based on user profile or purchase history. The presumption regarding the availability of a comprehensive initial purchase history is just generally false. Besides, statistical information based on retail chains' accounting and bonus card systems limits the service scope to a particular retail chain inventory, which is generally undesired.

In real life there are multiple grocery retail companies within each language region managing multiple retail chains or brands targeted at specific consumer groups, which themselves host a series of individual grocery shops that have variable inventory depending on e.g. area, ethnicity, local distributors, product availability and shop floor space. Due to the fact that customer loyalty-limited grocery recommendation logic should not be bound to singular retailer or loyalty program, or to the precondition of availability of comprehensive statistical purchase history information, the contemporary assisted shopping solutions fail in many respects. On the other hand, to train a computer apparatus to recognize family food consumption preferences a person, a recipe or a product at a time is inefficient or unpractical, usually both.

### SUMMARY OF THE INVENTION

The objective is to at least alleviate one or more aforesaid problems and to provide an innovative technical arrangement and related method for such purpose in the context of assisted shopping.

The objective is achieved by different embodiments of an electronic arrangement suitable for producing foodstuff recommendations and thus facilitating shopping in grocery stores and the like, said arrangement comprising a number of computer apparatuses, such as a server device, comprising:
a semantic context management entity configured to maintain semantic context-defining user information relative to a plurality of users, wherein said user information indicates user preferences relative to groceries based on obtained explicit or implicit preference information, such as allergy information input by a user and behavioral data like purchase history information obtained relative to the user, respectively,
a base item recommendation entity configured to determine, for a first user, a plurality of more generic grocery recommendations based on the semantic context of the first user and the semantic contexts of a number, preferably a plurality, of other users considered as neighbors to the first user according to predetermined similarity criteria, and
a product recommendation entity configured to derive, for the first user, a shopping list incorporating a plurality of recommended products relative to a predetermined, optionally user-selected, store offering such products, the recommended products representing the more specific instances of the determined more generic grocery recommendations and being derived utilizing knowledge of the store's product range, preferably also current stock, as well as of the semantic context of the first user and preferably of said plurality of neighboring other users.

Thereby, multi-resolution approach, e.g. ‘two-step’ or ‘two-level’ approach, may be cleverly utilized in providing the recommendations. More generic, or more categorical, recommendations may be initially determined as base item recommendations and subsequently utilized for more exact product matching relative to the actual product inventory of a number of predetermined (static or dynamically selected) stores such as one or more stores physically located nearest to the user in question based on user-adjustable location preference and/or e.g. technically monitored location information, which may be obtained utilizing satellite-based positioning and/or cellular or data network-based positioning, for instance.

In one embodiment, the arrangement is configured to determine at least part of recommended products and/or the more generic grocery (base item) recommendations through establishing indications of probabilities that reflect the estimated first user's need or desire to obtain, i.e. purchase, such. A number of predetermined semantic algorithms may be utilized in the task. A neighborhood graph derived based on the plurality of other users similar to the first user may be applied. Decision tree(s) may be applied. A predetermined number of products and/or more generic grocery recommendations (base item recommendations) with highest probability may be selected for further processing such as inclusion in a shopping list. Alternatively, a probability threshold may be applied to determine the selected ones instead of predetermined limitation on the number of list items.

In one, other either supplementary or alternative embodiment, the arrangement is configured to further adapt, or temporally correlate, a more generic grocery (base item) recommendation through utilization of available historical data, such as information on the instant when a particular grocery was previously purchased, and e.g. estimated consumption rate of the particular grocery. For example, if an instance of the base item, such as toothpaste, was obtained not too long ago by the first user according to the estimated consumption rate, the associated probability of the base item may be lowered.

In a further either supplementary or alternative embodiment, the arrangement is configured, in order to maintain semantic context for a user, to utilize at least one information element selected from the group consisting of: feedback data relative to a shopping list, feedback data relative to a recommended product, feedback data relative to a recommended base item, purchase history data, preference information relative to base items, preference information relative to products, user-defined allergy information or other restriction information, user-defined dislike information, product consumption history data, base item consumption history data, preferred recipe data, family data, family size, preference data relative to price, preference data relative to fat percentage, preference data relative to energy amount, preference data relative to nutrients, preference data relative to sugar, and preference data relative to product brands. Preference data and/or feedback data may be defined by explicit user input including voting or implicitly deduced based on available information such as purchase history information.

Yet in a further, either supplementary or alternative embodiment the arrangement is configured to add an indication of a product or related base item to, or to high-light such if already present in, the semantic context of a user upon fulfillment of a predetermined condition. The condition may include obtaining an indication of product preference such as product purchase or product addition in a shopping list by the user. Alternatively or additionally, various characterizing tags associated with the product, such as ‘low fat’ or ‘economy’, may be added to and/or highlighted in the context. The tags may thus describe the product as to the properties thereof. The tags may indicate the base item category or categories of each product.

Still in a further either supplementary or alternative embodiment the arrangement is configured to determine a user or user group-specific indication of product suitability preferably to each product of a store. The indication may be realized as a numerical value such as percentage value implying the probability of the suitability calculated. Such determination may be executed upon need or in a timed manner, e.g. once a day or once a week. Optionally, the arrangement is configured to determine such indication to each product falling under at least one base item (category) when such base item is present in the base items recommendations of the user to whom the shopping list is to be generated.

In a further, either supplementary or alternative, embodiment the arrangement is configured to give more weight, while determining recommendations, to the semantic context of a user in the plurality of other users that is closer, or more similar, to the first user than to the context of a further user being more distant to the first user according to predetermined criterion.

In a further, either supplementary or alternative, embodiment the arrangement is configured to provide user group-specific recommendations to the first user instead of, or in addition to, fully personal recommendations. A user group may refer to a family naturally including a plurality of users, for example. The users of the group may have been registered in the service maintained by the arrangement as both private users and members of at least one group. In addition to individual preferences and other user information, also particular group preferences and/or other group-specific information may be defined in and stored by the arrangement.

When providing group-specific recommendations, user information regarding each individual of the group may be first determined. Then the neighboring (similar) other users for each individual may be determined. Collective recommendations to the group may be formed based on available information concerning both group members and neighboring users.

In a further, either supplementary or alternative, embodiment the arrangement is configured to obtain control input from the first user to adapt or remove the recommendations and/or to add new items thereto. Manual control actions such as adaptations, removals and insertions may be configured to affect the user's semantic context as indications of preferences and/or user feedback.

In another aspect of the present invention, a method for automated generation of a grocery shopping list to be performed by an electronic apparatus or a plurality of at least functionally connected electronic apparatuses, comprises:
obtaining and maintaining semantic context-defining user information relative to a plurality of users, wherein said user information indicates user preferences relative to groceries based on obtained explicit or implicit preference information, such as allergy information input by a user and behavioral data like purchase history information obtained relative to the user, respectively,
determining, for a first user, a plurality of more generic grocery recommendations based on the semantic context of the first user and the semantic contexts of a number of other users considered as neighboring the first user according to predetermined similarity criteria,
selecting a grocery store according to a number of predetermined selection rules and/or user input,
constructing, for the first user, an initial shopping list incorporating a plurality of recommended products, the recommended products representing the more specific instances of the determined more generic grocery recommendations and being derived utilizing knowledge of the store's product range, preferably also current stock, as well as of the semantic context of the first user and preferably of said plurality of other users, and
indicating said initial shopping list to the first user for review, modification and/or acceptance optionally via a message such as e-mail or via the UI of a service application.

The utility of the present invention arises from a variety of reasons depending on each particular embodiment thereof. It may facilitate generating retailer independent grocery recommendations through semantic matching and machine learning in a collaborative media environment. It may induce automated grocery shopping predictions that are dynamically bound to the selected store's inventory. The suggested solution may provide product recommendations, such as grocery recommendations, potentially with no or little prior purchase history, adapt a user's shopping list to the inventory of the selected store even at the very moment the user enters the store and utilize purchase frequency and preferences of a larger entity than mere single user, such as a family covering a plurality of persons with minimal amount of family purchase history information or background knowledge, basing the computation on habits of like-minded individuals. This greatly reduces the amount of seed information needed to create accurate recommendations for new user. In addition, the system may adapt to new shopping behavior much more aggressively than traditional history-based recommendation systems as the convergence in neighbor graph is often radically faster than the emergence of statistical patterns in purchase history.

The end user may be directly recommended what to buy and which (end) product to select. In the UK a typical person orders online an extensive shopping basket on average once a week and spends about one hour planning the order in the Internet, for example. Recommendation and relevance based discovery as suggested herein allows the user to reduce the time spend with planning grocery purchases considerably, e.g. about 50%. From the consumer user's standpoint it is beneficial that the product binding to store inventory is dynamic and current. This enables the user to checkout his basket from online grocery of his selection or to use e.g. his mobile phone's GPS to determine the store and available inventory not until entering the corresponding building, thus answering the age old question “what should I buy today?” retail vendor independently. From business standpoint the dynamic binding to store inventory allows system manufacturer to technically distribute the solution to multiple chains with thousands of varied inventory stores.

It should be generally understood that in connection with the present invention the associated social network or collaborative media services may utilize a neighborhood model in order to classify users with similar social context, for example. Social context enables practical application of mathematical methods, in which recommendations can be derived from relatively small amount of seed- or purchase history information through utilization of the model.

The term “grocery” refers herein to whatever tangible foodstuff, drinks, and other consumer goods, such as cleaning products, personal hygiene products, batteries, toilet paper, etc. one may acquire via a physical store or virtual market.

The expression “a number of” refers herein to any positive integer starting from one (1), e.g. to one, two, or three.

The expression “a plurality of” refers herein to any positive integer starting from two (2), e.g. to two, three, or four.

The term “element” may herein refer also to a multi-part element with multiple functionally and optionally also physically connected elements in addition to single-part or integrated elements.

The terms “a” and “an”, as used herein, are defined as one or more than one.

The terms “first” and “second” are used herein to distinguish an element from other element and not to denote any particular order or importance if not otherwise explicitly indicated.

The term “or” refers to a single element of stated alternative elements or a combination of two or more elements, i.e. “inclusive” or. For example, the phrase “explicit or implicit preference data” refers to explicit preference data, implicit preference data, or both explicit and implicit preference data.

### BRIEF DESCRIPTION OF THE RELATED DRAWINGS

Next the present invention is described in more detail with reference to the appended drawings in which

FIG. 1 is an illustration of a merely exemplary embodiment according to the present invention, depicting various potential components of the associated system.

FIG. 2 is a flow chart of a method according to an embodiment of the present invention supplemented with indications of the related executing, at least logical, entities.

FIG. 3 is a conceptual representation of an embodiment of the suggested solution for facilitating shopping and automated shopping list construction.

### DETAILED DESCRIPTION OF THE EMBODIMENTS

In various embodiments of the present invention, a multi-factor or multi-step, such as two-factor/two-step, recommendation logic to predict future grocery purchases is advantageously applied. The provided arrangement is based on semantic recommendations, which may be computed by a network server or a cloud-based internet service comprising a plurality of servers, for instance. Information regarding the predicted grocery purchases may be delivered towards users via service satellites to virtual places where users generally spend time (e.g. Facebook) and/or to the internet devices that the users carry with them (e.g. iPhone). The service is preferably offered to the users in their habitat, on their own terms.

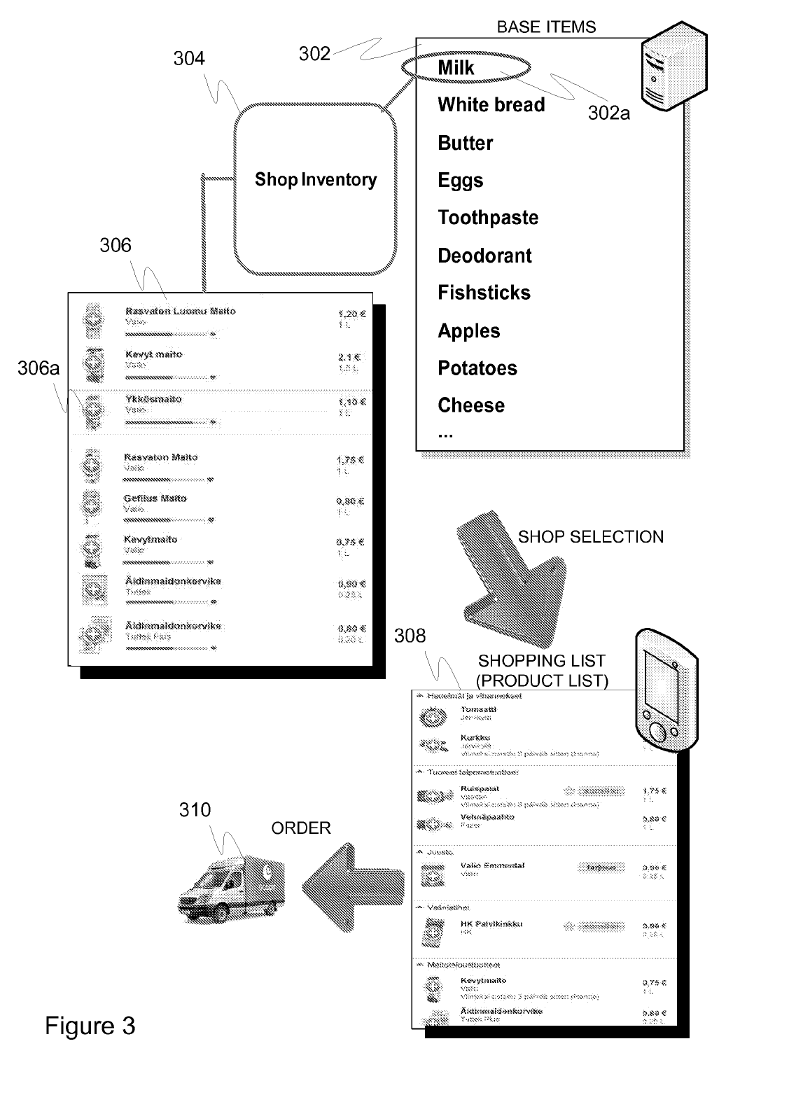

With reference to FIG. 3, a service entity such as a server and the service logic associated therewith may be first configured to determine, regarding a user of the service, a list or other structure 302 of more generic grocery recommendations, i.e. a list of recommended base items, 302a depending on the semantic context of the user indicative of user preferences and various potential other factors as to be described in more detail hereinafter. The more generic grocery recommendations 302a may include category-type elements that do not as such typically explicitly identify any particular product (e.g. product code indicative of brand and/or unit size) such as “milk” or “bread”. From the service standpoint, the constructed base item entity 302 may be kept hidden from the service end users, or alternatively, also the end users may be provided with access to more generic recommendations in addition to actual product recommendations, if seen useful.

Regarding the potential relationship between base items and products more explicitly defined, in a typical geographic region e.g. base item “milk” 302a may indeed refer up to several hundred or thousand identifiable consumer products with distinct identifier such as EAN (International Article Number) or GTIN (Global Trade Item Number). A retailer can distribute a subset of these products and a grocery store of a specific chain may have subset of these products in the store inventory depending on various factors, such as floor space and product popularity. Even so, the base item “milk” may still refer to tens or hundreds of distinct consumer products 306a in the context of the store 304 that user has picked out via the service or maybe just walked into (and automatically detected by the system on the basis of e.g. positioning such as GPS (Global Positioning System) data).

In different embodiments of the present invention each distinct product within geographic region (e.g. just a preselected store or larger geographical area within a certain radius from the user's home or other relevant location, which may convert into product ranges of multiple stores within the area; additionally/alternatively the inventories of “ubiquitous” online stores may be considered) may be preferably computed a user-specific relevancy index that measures the suitability of the distinct product for a user or user group. Again, semantic algorithms, decision trees and statistical data derived neighborhood graph may be advantageously applied to approximate the relevancy index or other indication of personal suitability for each product. Thus the products falling under the same base category may be mutually ranked and their presence in a selected shop's actual or theoretical inventory 306 utilized as a filter for ultimately selecting the product to be included in the more specific shopping list.

Combination of base item determination and actual product determination is applied for generating a personal shopping list recommendation 308 that contains the items user is likely to purchase in a form of distinct products that are most relevant to him. The user may optionally edit the generated personal shopping list and take it along electronically (e.g. on a PDA) or as a printed copy when visiting the premises of the selected grocery store, or send a corresponding order 310 to the selected online shop with home delivery, for example.

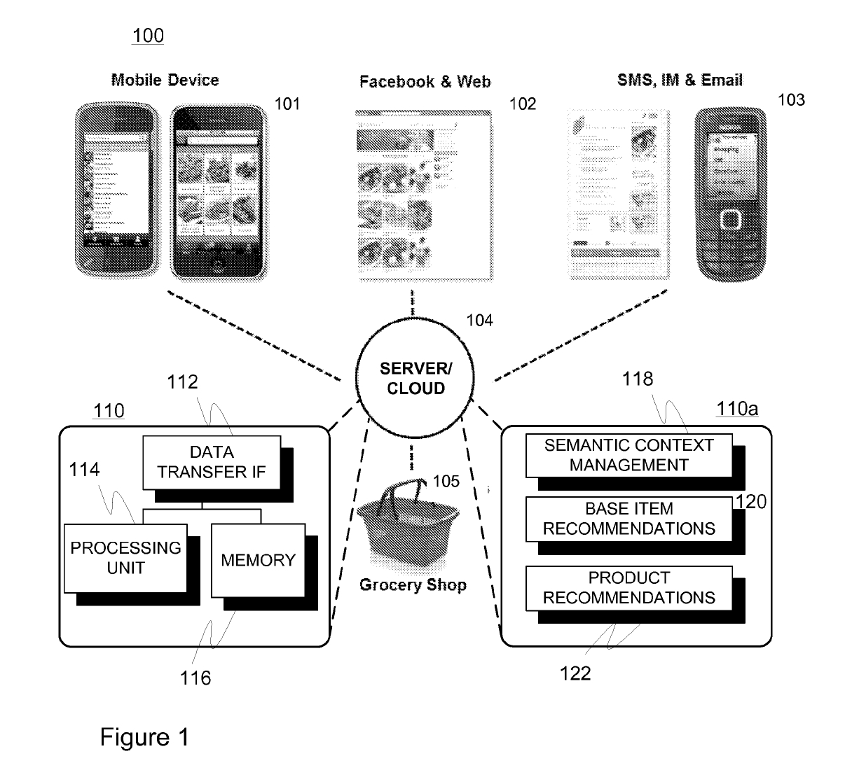

In FIG. 1 an illustration of a recommendation system according to the present invention is provided according to one embodiment thereof.

A number of shopping list applications and related client architectures 101, 102, 103 may be based e.g. on service satellites, which communicate with the service server 104 over the internet. The server 104 may herein refer to a single server or corresponding computer apparatus, or a plurality of those configured for mutual cooperation and optionally even dynamically allocated from a cloud computing environment, for example.

At 110 merely exemplary internals of a server entity 104 are shown from hardware perspective including at least one processing device, or “processing unit”, 114 such as a microprocessor, at least one memory element 116 such as a memory chip, and a data transfer interface 112 such as a wired or wireless transceiver operable e.g. in local area network such as Ethernet or WLAN (Wireless LAN), for example, and preferably functionally connected to the internet.

From more functional standpoint as indicated by item 110a in the figure, the service implemented by the server 104 may comprise logics, i.e. at least logically separable entities, such as a semantic context management entity 118, a base item recommendation entity 120, and a product recommendation entity 122. The entities 118, 120, 122 may be defined via software (in practice, may be separate, integrated, or e.g. split sw elements) and realized through processing device-based execution of instructions stored in the memory 116, i.e. the processing device 114 and thus the whole server device 104 may be configured to execute a number of tasks defined by the instructions.

The service satellites may be made available as a web service, “app” to existing social media service and connected devices such as mobile phones, internet tablets and connected TV's. Furthermore, widgets and similar web apps may be provided to other web compliant environments. The service 104 may be configured to determine the shopping list automatically by selecting therein a number of products based on the semantic context of the user.

Additionally, the service (server) 104 may be configured to enable the user to manually input, via a provided UI of the service, one or more products on the shopping list, edit the list (delete or change system-suggested products, for instance), confirm the list items or the list as a whole, check-out the related order from an automatically or manually selected store, discard the list, download or forward the list, store the list and/or print the list among other potential features. In some embodiments, manual verification of automatically compiled shopping list is not mandatory. E.g. a user-selectable setting may be provided to enable the user to decide whether to rely on computer-defined lists (and optionally letting the service to automatically place the related orders optionally in a timed manner, e.g. weekly) or require service to ask for user verification. The service 104 may be functionally connected to a number of stores 105 for electronically placing orders based on generated the shopping lists, for instance.

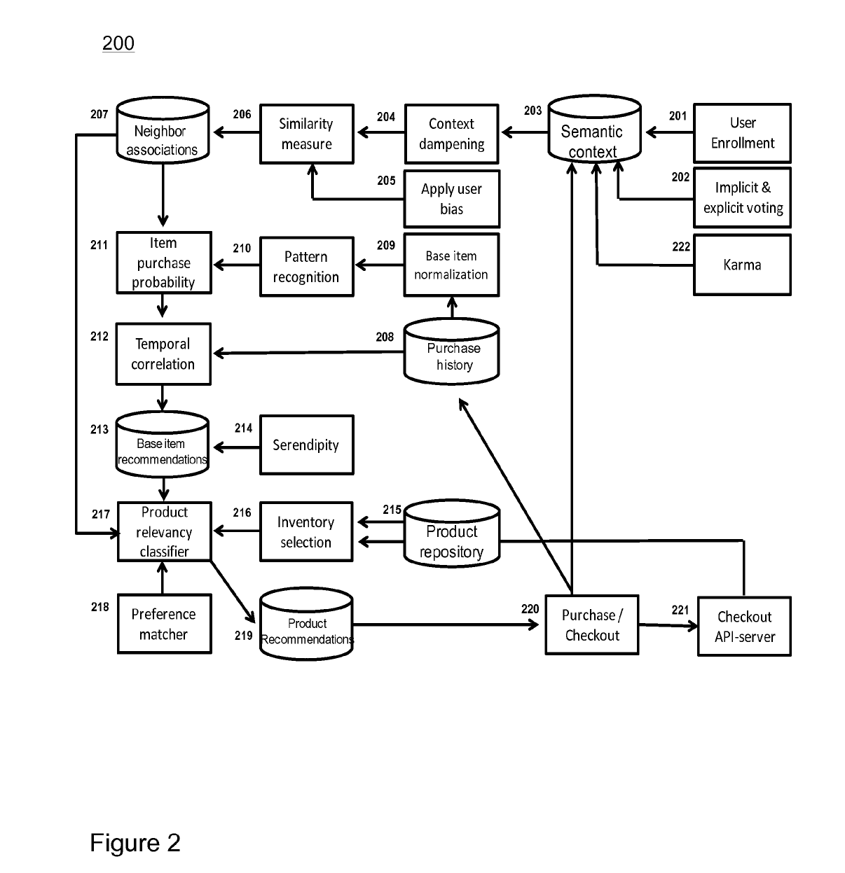

FIG. 2 illustrates at 200 an embodiment of the suggested method that the feasible electronic device such as a server may be configured to execute in accordance with the present invention. Reverting to the actual recommendation mechanisms and as alluded above, a number of behavioral characteristics of a user may be defined or implied by his semantic context. The semantic context may be realized as a dynamic feature vector comprising weighted attribute tags that may be used for user classification, for instance. The semantic context for a new user may be created during registration or user enrollment 201 relative to the service. There user may be asked a series of guiding questions regarding his habits, preferences, allergies, favorite products and/or family composition, which are then converted into his/her semantic context, i.e. entity that manages such information utilizing a number of data structures therefor, for example. The first time classification of the new user and his initial neighbors is preferably based on the exploitation of guiding questions.

Individual users may generally express their opinions within the service by implicit or explicit voting 202 on consumer products with distinct EAN or GTIN, for example. Additionally, automated base item inclusions (more generic grocery recommendations) may be optionally voted as well.

A vote feedback may be generally expressed through e.g. ternary logic incorporating positive, negative and high-impedance votes. Positive votes indicate favorable reaction and are expressed e.g. by voting thumb up (explicit), adding product item to shopping basket (implicit) or purchasing the item (implicit). Negative votes indicate disliking and are expressed e.g. by voting thumb down (explicit) or discarding items (implicit). Ignoring or passing on recommendation may be count as a high-impedance vote, for example.

When a distinct product is voted within the service the associated product attribute tag(s) and related base item classification tag(s) may be added to the user's semantic context 203, or an update be executed such as their weight increased or decreased accordingly should they already exist.

Furthermore, all or predetermined user context attribute tags may be associated with dampening times and subject to context dampening 204. The context dampening defines that recently amended tags may have a higher weight when determining neighborhood network and purchase probability, and the tag weight thus decay, optionally exponentially, as function of time until it reaches e.g. a predetermined cutoff point. As a result the events that occurred in distant past may have reduced effect on future recommendation(s) likely reflecting the current state, i.e. user's preferences and habits, better.

In order to compute accurate recommendation each user preferably has at least one determined set of neighbors. The neighbors represent references to like-minded users with similar habits in the service.

Neighbor association 207 may be calculated for each user by comparing the users' semantic contexts 203, or feature vectors. The similarities are preferably determined from individual users' feature vectors by applying Pearson's correlation or other similarity measure 206. The result is large mesh of users that defines similarity relation between different users by closeness or weight of the connecting association. A fixed set of closest neighbors may be then amended into a pre-computed user or group (i.e. comprising a plurality of users such as family members) neighborhood graph.

Group such as family recommendation aspect may often turn out valuable part of the predicting groceries depending on the embodiment. Noticeably, in some non-grocery related recommendation logics, the recommended products are consequent to preferences of a single user or derived from item-to-item associations (people who purchased X also bought Y). If e.g. one family member purchased a book, this would not imply, however, that other family members need to read it. One shall understand that with grocery recommendations the opposite typically applies. Should one member of family purchase food, this would in fact imply that other family members generally need to be able to eat it too.

Accordingly, the suggested grocery recommendation logic may be based on group similarity measure 206. Here, the neighbor associations for group entities (e.g. family) may be composed as a union of member similarity mesh wherein the resulting vertex weights are a function of group member neighbor distances and group size. Therefore, the resulting grocery recommendations according to the invention may be made collaborative.

With group recommendations, a user bias 205 is preferably applied on collaborative recommendations. As group recommendations are composed utilizing joint neighbors of its members, an individual within group may influence the outcome heavily. Statistically an unbiased system may yield better overall result. However, since an active user may be unaware of group members' preferences, the recommendation may incidentally seem to contain items active user is not prone to purchase or products that are less relevant to active user. A recommendation bias towards the active user preferences allows extracting more positive purchase decisions and may be thus preferred. Therefore bias favoring the active user may be achieved by increasing the weight of active user's neighbors in group neighbor graph in relation to group member count.

First step of two-step recommendation logic comprises approximating purchase probabilities for the base items 213 as a backbone of the recommendations. The base items represent generic products or product categories such as “milk”, “butter” or “break”, which function as reference index to group of consumer products with distinct EAN or GTIN, for instance. The base items may be associated with a number of weighted characterizing attribute tags in within the user's semantic context 203, e.g. “milk” can be associated with attribute tags “skimmed”, “fat free” and “organic”.

Each user within the service may have a purchase history 208 of distinct products, which contains references to base items 209. The initial purchase probability of base items may be therefore composed out of joint purchase histories of user's neighbors in correlation with closeness of specific neighbor, the user himself being closest. In case the user has no existing purchase history the information is preferably derived entirely from the neighbors.

A number of pattern recognition methods 210 may be applied to the joint purchase history to derive initial purchase probability of base items. A sensor agent entity may be made responsible for gathering numeric and/or symbolic observation information on each neighboring users' purchase history, referred to as an observation vector. Using this data statistical pattern matching, classification and e.g. Hidden Markov Model (HMM) may be utilized to calculate a purchase probability for each base item in the user's recommendation array. Hereby, the initial item purchase probability 211 may be based on time series observation vector gathered from neighboring users' base item purchase history. Principal Components Analysis (PCA) may be utilized to reduce the dimensionality of observations and to disregard data unrelated to base item occurrence probability. Utilizing base items purchase history for statistical analysis enables detecting distinct purchase patterns with limited historical data. In comparison, determining purchase patterns based on distinct product purchases would require very extensive retail vendor specific historical data.

The initial item purchase probability 211 for a base item is preferably adjusted with temporal correlation 212. The method may be especially used to correct base item purchase probability values with respect to the instant when the product was last bought, estimated purchase frequency and/or consumption time. All base items may have a predetermined, approximated purchase frequency and consumption time, which are used in case no user-specific values are available. The result of temporal correlation is base item recommendations 213, which may be or include a (time-adjusted) array of base items with purchase probabilities. One purpose of temporal correlation 212 may be to allow e.g. bi-monthly or other temporal rotation of less frequently purchased items such as “toothpaste”.

Regardless of temporal correlation a static set of user neighbors and static purchase pattern may create a closed ecosystem in terms of recommendations. A fixed group of neighbors recommend similar base-items to each other, would lack variance and prevent people from discovering new and noteworthy things.

To cope with the above potential problem, a pseudo-random stream of new items referred as serendipity 214 is added to use's base item recommendations. The algorithms used to derive serendipity may vary greatly; however for purposes of this invention serendipity introduces a steady rotation of new base items that comes from outside of neighboring users and hence disrupts the potential closed ecosystem loop.

The other phase of the recommendation logic comprises product relevancy classification 217. This preferably includes pre-computing indication of product relevance preferably for each known product, e.g. with distinct EAN or GTIN, available for a user within a geographic region associated with the user. The product relevance may be a fuzzy logic value between 0 and 1 that represents the user or user group-specific product suitability measure. In order to achieve this, the service may be configured to classify the available products within the geographic region based on products details, including but not limited to e.g. packet size, price points, brand, nutritional values, ingredient information, additives and/or production values. The product detail information may be electronically gathered from optionally e.g. nation or continent wide, i.e. central(ized), product repository 215 such as GS1, SA2 WorldSync or local brand bank(s). The store specific inventory selection 216 and pricing information may be commonly harvested from a retailer's checkout API-server 221 (application programming interface), such as public Tesco-API, for example.

The product relevancy default indication may be set as 0.5, for instance. In a basic case the product relevancy value may be incremented or decremented based on implicit or explicit voting 202 of user within the service, such as product adding to basket, rating and commenting the product, voting the product thumb up or thumb down or adding the product to favorites.

In case where product relevancy is not explicitly or implicitly defined by user, the product relevancy classifier 217 derives this information preferably from like-minded people, i.e. neighbors. The peer referral relevancy values may be derived from the neighbor's relevancy values in correlation with closeness of specific neighbor and associated karma 222, utilizing the opinion of the closest and most reliable available neighbor with implicit or explicit relevancy value. In case no peer referral relevancy is available the base value of relevancy may be adjusted with normalized general popularity (or unpopularity) of the product, for example.

The above mentioned karma 222 is a method used primarily in community oriented services for moderation of user generated content (i.e. to remove abusive content and comply with DMCA), such as product reviews. User karma rating reflects source reliability. Generally when user is active within a community, generates good content and gains followers, his karma rating increases, and vice versa. The present invention enables using a similar method as source reliability for peer referral relevancy determination.

Furthermore, a user preference matcher 218 may calculate a secondary relevancy score for each classified product. Users or user groups may have a series of constraints and preferences defined within their semantic context 203. These conditions may potentially radically influence product selection criteria. Typical the conditions include, but are not limited to, budget and diet restrictions, ecological purchase preferences, brand loyalty, medical conditions and/or food allergies. Therefore, a similarity between the user's semantic context and classified product details is calculated using a similarity method. The result is then normalized and amended to product relevancy value.

The base item recommendations 213 may be then dynamically mapped into products with highest product relevancy score 217 available in the inventory 215 of the selected store. A classifier entity may traverse through base item recommendation array and associate the base items into a sequence of distinct products sorted by the order of product relevancy. The result set may be limited into intersection of products available in selected store inventory. As a consequence, the end user is preferably presented with product recommendations 219 that contain products he is most likely to purchase at given time and that contains the most relevant product selections that comply with the user's personal preferences.

The above recommendations may be then indicated to the user as (a template for) electronic shopping list that may be optionally modified by the user and/or submitted to a selected online grocery store checkout API-server 221.

Various embodiments of the method described above may be implemented utilizing computer software executed by a processing device such as a microprocessor, microcontroller, programmable logic array, or a plurality or combination of any of those as generally illustrated in FIG. 1. The software and other data may be stored in processing device-integrated or separate, at least functionally-connected, memory device such as a memory chip. The computer software may be generally embodied on a computer readable carrier medium such as a memory stick, memory card, hard disc, optical disc, etc. The software may be run on at least one server apparatus. A client device or service may execute related client software. Such software may refer to a dedicated client application or a browser-executable application, for example.

It is clear to a person skilled in the art that with the advancement of technology the basic ideas of the present invention may be implemented in various ways without diverging from the fulcrum of the present invention. The invention and its embodiments are thus not limited to the examples described above; instead they may generally vary within the scope of the appended claims.

1. An electronic arrangement (104, 110, 110a) for producing foodstuff recommendations and thus facilitating shopping in grocery stores and the like, said arrangement comprising a number of computer apparatuses, such as at least one server device, said arrangement comprising:
a semantic context management entity (118, 203) configured to maintain semantic context-defining user information relative to a plurality of users, wherein said user information indicates user preferences relative to groceries based on obtained explicit or implicit preference information,
a base item recommendation entity (120, 204-214) configured to determine, for a first user, a plurality of more generic grocery recommendations (302, 302a) based on the semantic context of the first user and the semantic contexts of a number, preferably a plurality, of other users considered as neighbors to the first user according to predetermined similarity criteria, and
a product recommendation entity (122, 217, 218) configured to derive, for the first user, a shopping list (219, 308) incorporating a plurality of recommended products (306a) relative to a predetermined, optionally user-selected, store (105) offering such products, the recommended products representing more specific instances of the determined more generic grocery recommendations and being derived utilizing knowledge of the store's product range or current stock (216, 304) as well as of the semantic context of the first user and preferably of said plurality of neighboring other users.

2. The arrangement of claim 1, configured to maintain semantic-context defining user information indicative of user preferences utilizing a dynamic feature vector preferably comprising a number of weighted attribute tags associated with products or more generic base items.

3. The arrangement of claim 2, configured, in response to positive preference information obtained relative to a product, to increase the associated weight of the product or corresponding more generic base item.

4. The arrangement of claim 1, configured to put higher weight on more recent user information than older user information (204).

5. The arrangement of claim 1, configured to maintain user information based on at least one obtained information element selected from the group consisting of: behavioral data, purchase history data, feedback data relative to a shopping list, feedback data relative to a recommended product, feedback data relative to a recommended more generic base item, purchase history data, preference information relative to base items, preference information relative to products, user-defined allergy information or other restriction information, user-defined dislike information, product consumption history data, base item consumption history data, preferred recipe data, family data, family size, preference data relative to price, preference data relative to fat percentage, preference data relative to energy amount, preference data relative to nutrients, preference data relative to sugar, and preference data relative to product brands.

6. The arrangement of claim 1, configured to determine said plurality of more generic grocery recommendations through establishing indications of related purchase probabilities (211), wherein the purchase history of the first user and preferably of said plurality of other users is advantageously applied (207-210) in determining the indications, and further wherein statistical pattern matching, classification or HMM (Hidden Markov Model) is optionally utilized.

7. The arrangement of claim 1, configured to determine said plurality of other users neighboring the first user through utilization of Pearson correlation coefficient as a similarity criterion (206, 207).

8. The arrangement of claim 1, configured to establish said plurality of more generic grocery recommendations or the shopping list of more specific products as collaborative recommendation in view of a group of users, such as a family, the structure of which has been input to the arrangement.

9. The arrangement of claim 1, configured to derive the products for the shopping list based on electronically organized product detail information (215), optionally accessed or obtained via an external product repository such as GS1 or SA2 WorldSync.

10. The arrangement of claim 1, configured to receive user input and adapt the shopping list based thereon, optionally by removing a recommended product therefrom, adding a new product therein or including a user note therein.

11. The arrangement of claim 1, configured to provide a feedback UI (user interface) feature to the users regarding the recommended products or shopping list in general, optionally applying at least ternary logic with substantially positive, negative and at least one, more indefinite, voting options.

12. The arrangement of claim 1, configured to determine product relevancy indications (217) for a larger number of products from the standpoint of the first user in order to derive said shopping list incorporating said plurality of recommended products, optionally further configured to apply user reliability information for product relevancy determination.

13. The arrangement of claim 1, configured to introduce a new item in the shopping list randomly or pseudo-randomly (214) optionally based on information regarding the sale products available in the store.

14. The arrangement of claim 1, wherein different products are mutually distinguished utilizing distinct product identifiers, optionally EAN (International Article Number) or GTIN (Global Trade Item Number).

15. The arrangement of claim 1, configured to adapt the relevance of a more generic grocery recommendation through utilization of at least one temporal adjusting factor (208, 212) selected from a group consisting of: instant of last purchase, estimated purchase frequency and estimated consumption time.

16. The arrangement of claim 1, configured to apply position data, such as network-based or satellite-based positioning data, regarding the first user to select the store for shopping list generation based on the more generic grocery recommendations.

17. The arrangement of claim 1, configured to apply user input, such as dynamic input or user-adjusted settings, to select the store.

18. The arrangement of claim 1, configured to apply a predetermined area such as the area defined by a predetermined radius around user-related location, such as home location, to determine the store.

19. A method for automated generation of a grocery shopping list to be performed by an electronic apparatus or a plurality of at least functionally connected electronic apparatuses, comprising:
obtaining and maintaining (201, 202, 222, 203, 220) semantic context-defining user information relative to a plurality of users, wherein said user information indicates user preferences relative to groceries based on obtained explicit or implicit preference information, such as allergy information input by a user or behavioral data like purchase history information obtained relative to the user,
determining, for a first user, a plurality of more generic grocery recommendations based on the semantic context of the first user and the semantic contexts of a number of other users considered as neighboring the first user according to predetermined similarity criteria (204-213),
selecting a grocery store according to a number of predetermined selection rules or user input,
constructing, for the first user, an initial shopping list incorporating a plurality of recommended products, the recommended products representing the more specific instances of the determined more generic grocery recommendations and being derived utilizing knowledge of the store's product range or current stock, as well as of the semantic context of the first user and preferably of said plurality of other users (215-219), and
indicating said initial shopping list (308) to the first user for review, modification and/or acceptance preferably via the UI (user interface) of an associated service application.

20. A computer program comprising code means adapted, when run on a computer, to execute the method items of claim 19.

21. A carrier medium, such as a memory card or an optical disc, adapted to contain the computer program of claim 20.
